(19) United States
(12) Patent Application Publication
(10) Pub. No.: US 2005/0237307 A1
(43) Pub. Date: Oct. 27, 2005

(54) Transparent laminate, pen-input image display, and image display method

(76) Inventors: Yoshihiro Hieda, Osaka (JP); Tomonori Noguchi, Osaka (JP); Ikuo Kawamoto, Osaka (JP); Toshiyuki Umehara, Osaka (JP); Minoru Miyatake, Osaka (JP)

Correspondence Address: WESTERMAN, HATTORI, DANIELS & ADRIAN, LLP, 1250 CONNECTICUT AVENUE, NW, SUITE 700, WASHINGTON, DC, 20036, US

(21) Appl. No.: 10/519,800

(22) PCT Filed: Feb. 5, 2004
(86) PCT No.: PCT/JP04/01201

§ 371 Date: Dec. 29, 2004

(30) Foreign Application Priority Data
Feb. 5, 2003 (JP) 2003-28299
Dec. 26, 2003 (JP) 2003-431998

(51) Int. Cl. G09G 5/00

(52) U.S. Cl. 345/173

(57) ABSTRACT

A surface-treated film, a transparent rigid layer and a transparent relaxing layer are laminated in this order to form a transparent laminate. Particularly, the transparent relaxing layer is made of an adhesive. The dynamic storage modulus G′ of the transparent rigid layer at 20° C. is not lower than 2×10⁸ Pa. On the other hand, the dynamic storage modulus G′ of the transparent relaxing layer at 20° C. is not higher than 1×10⁷ Pa. The transparent laminate is directly laminated onto a visual surface side (pen-input side) of a liquid crystal panel provided as an image display panel so that the transparent relaxing layer is placed inward. Thus, a pen-input image display device is produced.

### FIELD OF THE INVENTION

The present invention relates to a pen-input touch panel attached to a front surface of an FDP display device such as a liquid crystal display, and more particularly to a transparent laminate attached to a touch panel type pen-input image display device using an electromagnetic induction system or a resistive film system, and an image display method using the same.

### BACKGROUND ART

Pen-input image display devices such as resistive film type or electromagnetic induction type pen-input liquid crystal displays have been already known and used publicly and known in patent documents (see JP 2001-243016 A).

In a “tablet PC” known as this type display, as shown in FIG. 6, a hard coated film 41 having an anti-reflection layer (or an anti-mirroring layer) is laminated onto one or each of surfaces of a protective sheet 43 made of an acrylic sheet etc. through an adhesive layer 42, and the protective sheet 43 is attached onto a visual surface side (pen-input side) of a liquid crystal panel 44 through a gap made of an air layer 45 having a distance of about 0.5 to 2 mm from the panel 44 in order to make pen-input smoothly and to prevent smearing on a liquid crystal screen from being caused by pen-input.

### DISCLOSURE OF THE INVENTION

It is however difficult in the conventional pen-input image display device to reduce the weight, size and thickness which is required in view of portability of the device since the protective sheet is formed. Moreover, image blurring is caused by a parallax and a reflection reducing process since there is the gap of the air layer. In addition, the tool force is so small that the feeling of drawing the pen becomes poor since a hard sheet such as an acrylic sheet is used as the protective sheet.

On the other hand, in a configuration in which an anti-reflection layer (or an anti-mirroring layer) or a polarizing plate and a retardation plate as an optical layer is provided directly on the image display panel without provision of the protective sheet, there is a problem in image smearing caused by the pen input, bad feeling of writing and breaking of the image display panel caused by impact of external force.

Upon such circumstances, an object of the present invention is to provide a panel attachment member which is used in a resistive film type or electromagnetic induction type pen-input image display device; in which slidability of an input pen can be retained, image smearing caused by the pen input can be reduced and a good feeling of writing can be provided; and which is effective in reducing weight, size and thickness, preventing double reflection of external light, preventing image blurring and preventing the crack of an image display panel due to impact. Another object of the invention is to provide a pen-input image display device and an image display method using the aforementioned panel attachment member.

The present inventors have made eager investigation to examine the problem. As a result, it has been found that when a transparent laminate prepared by laminating a surface-treated layer, a transparent rigid layer and a transparent relaxing layer having a specific thickness in this order is used in a resistive film type or electromagnetic induction type pen-input image display device, and the transparent laminate is directly struck onto a visual surface side (pen-input side) of an image display panel so that the transparent relaxing layer is disposed inward, slidability of an input pen can be retained, image smearing due to pen-input can be reduced, a good feeling of writing can be provided, and the transparent laminate is effective in reducing weight, size and thickness, preventing double reflection of external light, preventing image blurring and preventing the crack of the image display panel due to impact. Thus, the invention is accomplished.

That is, the invention relates to a transparent laminate for pen-input image display device, including a surface-treated layer, a transparent rigid layer, and a transparent relaxing layer having a thickness of from 0.2 to 2 mm, wherein the layers are laminated in this order.

Preferably, the transparent relaxing layer is made of an adhesive. Preferably, the dynamic storage modulus G′ of the transparent rigid layer at 20° C. is not lower than 2×10⁸ Pa. Preferably, the dynamic storage modulus G′ of the transparent relaxing layer 20° C. is not higher than 1×10⁷ Pa. Preferably, the thickness of the transparent rigid layer is from 0.15 to 2 mm. A pair-of transparent electrically conductive layers can be provided in any portion between the surface-treated layer and the transparent relaxing layer so as to face each other with separation of a predetermined distance.

The invention also relates to a pen-input image display device in which the transparent laminate is directly laminated onto a visual surface side (pen-input side) of the image display panel so that the transparent relaxing layer is disposed inward. Particularly, the invention can provide a pen-input image display device of the aforementioned configuration having such elastic deformability that a contact portion of the display device sinks inward to a depth of from 20 to 100 μm when an input pen touches a surface of the display device under a load of 300 g, but the contact portion of the display device is restored to its original state when the load is removed.

The invention further relates to a pen-input image display method in which a pen is input on the image display panel which is formed so that the transparent laminate is directly laminated onto a visual surface side (pen-input side) of the image display panel with the transparent relaxing layer being disposed inward. Particularly, the invention can provides a pen-input image display method of the aforementioned configuration having such elastic deformability that a contact portion of the display device sinks inward to a depth of from 20 to 100 μm when an input pen touches a surface of the display device under a load of 300 g, but the contact portion of the display device is restored to its original state when the load is removed.

As described above, in accordance with the invention, a surface-treated layer, a transparent rigid layer and a transparent relaxing layer are laminated in this order to form a transparent laminate. The transparent laminate is directly laminated onto a visual surface side of an image display panel through a suitable optical film or the like. Accordingly, because the gap of an air layer in a conventional protective sheet can be eliminated, parallax is eliminated. Image blurring caused by reflection can be prevented. Moreover, because there is no protective sheet, reduction in weight, size and thickness can be attained. The invention is so simple in configuration that reduction in cost can be attained. Moreover, image smearing due to pen-input can be reduced as a function. Moreover, while the feeling of writing can be kept good, the crack of the image display panel due to external impact can be prevented. In this manner, various effects can be provided.

### BRIEF DESCRIPTION OF THE DRAWINGS

FIG. 1 is a sectional view showing a transparent laminate according to the invention and an example of an electromagnetic induction type pen-input liquid crystal display device using the transparent laminate.

FIG. 2 is a sectional view showing a transparent laminate according to the invention and another example of an electromagnetic induction type pen-input liquid crystal display device using the transparent laminate.

FIG. 3 is a sectional view showing a transparent laminate according to the invention and an example of a resistive film type pen-input liquid crystal display device using the transparent laminate.

FIG. 4 is a sectional view showing a transparent laminate according to the invention and another example of a resistive film type pen-input liquid crystal display device using the transparent laminate.

FIG. 5 is a sectional view showing a transparent laminate according to the invention and a further example of an electromagnetic induction type pen-input liquid crystal display device using the transparent laminate.

FIG. 6 is a sectional view showing an example of a conventional pen-input liquid crystal display device.

### BEST MODE FOR CARRYING OUT THE INVENTION

An embodiment of the invention will be described below with reference to the drawings.

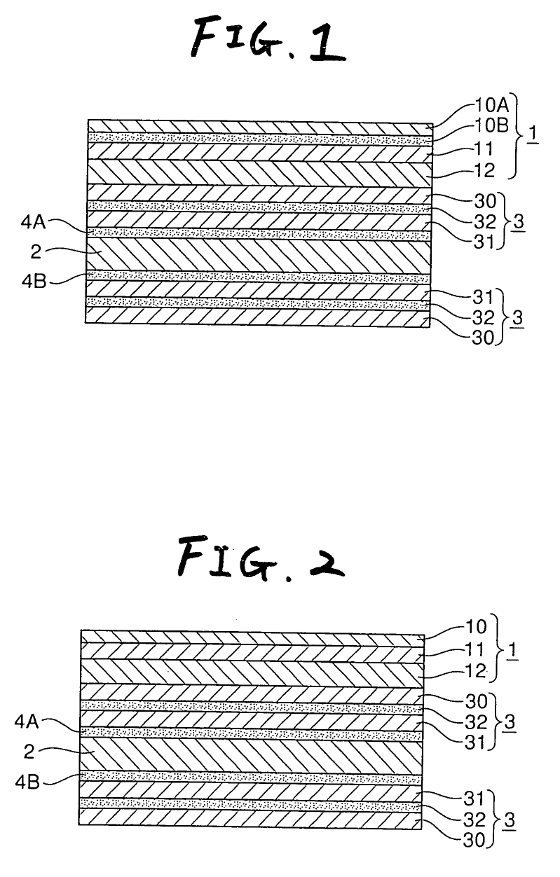

FIG. 1 shows a transparent laminate according to the invention and an example of an electromagnetic induction type pen-input image display device using the transparent laminate.

In the drawing, the reference numeral 1 designates a transparent laminate in which a surface-treated film 10A having at least one of an anti-reflection layer, an anti-mirroring layer and a hard coated layer is laminated on a transparent rigid layer 11 through a transparent adhesive layer 10B while a transparent relaxing layer 12 is laminated on the transparent rigid layer 11. The transparent laminate 1 is laminated onto a visual surface side (pen-input side) of a liquid crystal panel 2 as an image display panel through an optical film 3 so that the transparent relaxing layer 12 is disposed inward.

The optical film 3 is formed in such a manner that a polarizing plate 30 and a retardation plate (optically compensatory plate) 31 as optical layers are laminated on each other through a transparent adhesive layer 32. The optical sheet 3 is laminated onto the visual surface side (pen-input side) of the liquid crystal panel 2 by a transparent adhesive layer 4A so that the retardation plate 31 is disposed inward. An optical film 3 of the same is laminated onto a rear surface side of the liquid crystal panel 2, that is, onto a surface side opposite to the visual surface side by a transparent adhesive layer 4B so that the retardation plate 31 is also disposed inward.

A transparent film such as a polyester film hard-coated to resist frictional pen-input attachment is preferably used as the surface-treated film 10A as a surface-treated layer in the transparent laminate 1. Especially, a film having a surface hardness of 2H or larger is preferred. More especially, a film having a surface hardness of 3H or larger is preferred. If the hardness is smaller than 2H, scratch resistance to the pen runs short.

The coefficient of dynamic friction to pen-input is preferably from 0.02 to 0.03. If the coefficient of dynamic friction is too small, the pen slides rapidly. If the coefficient of dynamic friction is contrariwise too large, the pen slides so slowly and heavily that drawing characteristic of the pen is worsened.

Such hard coating can be performed by a conventionally known method. For example, hard coating can be performed by a method of forming a cured film using an ultraviolet- or electron beam-curable resin or a heat-curable resin such as an unsaturated polyester resin, an unsaturated acrylic resin, an unsaturated polyurethane resin or a polyamide resin.

The surface-treated film 10A preferably has an anti-reflection layer or an anti-mirroring layer for the purpose of preventing reflection of external light. The anti-reflection layer can be formed by a conventionally known anti-reflection treatment. On this occasion, an antistatic treatment for preventing dust deposit, a stain-proofing treatment for preventing fingerprint deposit and a suitable treatment for donating slidability may be carried out simultaneously. The anti-reflection layer and the anti-mirroring layer may be formed simultaneously.

The anti-mirroring layer is formed as a so-called antiglare layer for the purpose of preventing visibility of light transmitted through the polarizing plate from being disturbed by reflection of external light. For example, the anti-mirroring layer can be formed in such a manner that a fine roughness structure is given to a film surface by a surface roughening method such as sandblasting or embossing or by a method of mixing transparent fine particles.

Inorganic or organic fine particles with a mean particle size of 0.5 to 50 μm are used as the transparent fine particles. Examples of the inorganic or organic fine particles include silica, alumina, titania, zirconia, tin oxide, indium oxide, cadmium oxide, antimony oxide, and polymer beads such as polystyrene beads. The amount of the transparent fine particles used is selected to be generally in a range of from 2 to 50 parts by weight, preferably in a range of from 5 to 25 parts by weight with respect to 100 parts by weight of the resin for forming the roughness structure. The anti-mirroring layer may serve also as a diffusing layer (a vision enlarging function, etc.) for diffusing light transmitted through the polarizing plate to enlarge vision etc.

The transparent adhesive layer 10B used for laminating the surface-treated film 10A on the transparent rigid layer 11 is not particularly limited. A known adhesive such as an acrylic adhesive or a rubber adhesive having transparency can be used widely.

Incidentally, as shown in FIG. 2, a surface-treated layer 10 having at least one of an anti-reflection layer, an anti-mirroring layer and a hard coated layer may be directly formed in place of use of the surface-treated film 10A on the transparent rigid layer 11 so that use of the transparent adhesive layer 10B can be omitted. Also in this case, the surface-treated layer 10 is preferably formed so that the surface-treated layer 10 serves as an anti-reflection layer (or an anti-mirroring layer) and also as a hard coated layer. The other constituent members in FIG. 2 are the same as those in FIG. 1. Numerals the same as those in FIG. 1 are given to the other constituent members in FIG. 2 for the sake of omission of duplicated description.

In the transparent laminate 1, the transparent rigid layer 11 is provided for relaxing forcing stress due to pen-input to reduce smearing of an image. Therefore, the dynamic storage modulus G′ at 20° C. is preferably not smaller than 2×10⁸ Pa, further preferably not smaller than 5×10⁸ Pa. If the dynamic storage modulus G′ at 20° C. is smaller than 2×10⁸ Pa, the pen may sink so deeply that image smearing occurs easily. The thickness of the transparent rigid layer 11 is in a range of from 0.15 to 2 mm, preferably in a range of from 0.2 to 1 mm.

A plastic film excellent in transparency (transmittance of 70% or higher), excellent in mechanical strength and good in heat resistance is used as the transparent rigid layer. Specifically, a film made of a polyester resin, a (meth)acrylic resin, a polycarbonate resin, a polyethylene naphthalate resin, a polyethylene terephthalate resin, triacetylcellulose, an Arton resin, an epoxy resin, a polyimide resin, a polyetherimide resin, a poly amide resin, polysulfone, polyphenylene sulfide, polyether sulfone, or the like, is used. This film may be a single layer or a composition of two or more layers.

A film made of a single layer of a polyester resin or an epoxy resin or a combination of two or more layers of polyester and epoxy resins is most preferred from the point of view of transparency, heat resistance and mechanical strength.

Examples of the polyester resin include polyethylene terephthalate, polyethylene naphthalate, etc.

Examples of the epoxy resin include: bisphenol type such as bisphenol A type, bisphenol F type, bisphenol S type, or hydrogenated bisphenol (A, F or S) type; novolak type such as phenolic novolak type, or cresylic novolak type; nitrogen-containing ring type such as triglycidyl isocyanurate type, or hydantoin type; aromatic type such as alicyclic type, aliphatic type, or naphthalene type; low water absorption type such as glycidyl ether type, or biphenyl type; and dicyclo type, ester type, ether-ester type or modified type thereof. These epoxy resins may be used singly or as a combination of two or more types. The bisphenol A type, the alicyclic type, the triglycidyl isocyanurate type, etc. are especially preferred from the point of view of preventing discoloration, etc.

It is preferable that these epoxy resins have 100 to 1,000 epoxy equivalents and have a softening point of not higher than 120° C. in view of flexibility, strength, etc. of the film. To obtain a coating solution excellent in coating characteristic, film expandability etc., a two-part liquid mixture type exhibiting a liquid state at a temperature not higher than the coating temperature, especially at ordinary temperature is preferred.

Besides a curing agent and a curing accelerator, various known additives such as an age resister, a modifying agent, a surfactant, a dye, a pigment, a discoloration resistor, an ultraviolet absorbing agent, etc. heretofore used may be mixed with the aforementioned epoxy resin as occasion demands.

The curing agent is not particularly limited. One kind of curing agent or two kinds of curing agents may be used according to the kind of the epoxy resin.

Specific examples include: an organic acid compound such as tetrahydrophthalic acid, methyltetrahydrophthalic acid, hexahydrophthalic acid, or methylhexahydrophthalic acid; an amine compound such as ethylene diamine, propylene diamine, diethylene triamine, triethylene tetramine, amine adducts thereof, meta-phenylene diamine, diaminodiphenyl methane, or diaminodiphenyl sulfone; an amide compound such as dicyandiamide, or polyamide; a hydrazide compound such as dihydrazide; an imidazole compound such as methyl imidazole, 2-ethyl-4-methyl imidazole, ethyl imidazole, isopropyl imidazole, 2,4-dimethyl imidazole, phenyl imidazole, undecyl imidazole, heptadecyl imidazole, or 2-phenyl-4-methyl imidazole; an imidazoline compound such as methyl imidazoline, 2-ethyl-4-methyl imidazoline, ethyl imidazoline, isopropyl imidazoline, 2,4-dimethyl imidazoline, phenyl imidazoline, undecyl imidazoline, heptadecyl imidazoline, or 2-phenyl-4-methyl imidazoline; a phenol compound; a urea compound; and a polysulfide compound.

An acid anhydride compound such as phthalic anhydride, maleic anhydride, trimellitic anhydride, pyromellitic anhydride, nadic anhydride, glutaric anhydride, tetrahydrophthalic anhydride, methyltetrahydrophthalic anhydride, hexahydrophthalic anhydride, methylhexahydrophthalic anhydride, methyl nadic anhydride, dodecenylsuccinic anhydride, dichlorosuccinic anhydride, benzophenone tetracarboxylic anhydride, or chlorendic anhydride is also preferably used from the point of view of preventing discoloration. Especially, a colorless or light yellow acid anhydride curing agent having a molecular weight of about 140 to about 200 such as phthalic anhydride, tetrahydrophthalic anhydride, hexahydrophthalic anhydride, or methylhexahydrophthalic anhydride is preferred.

When an acid anhydride curing agent is used, the curing agent may be preferably mixed with the epoxy resin so that the resulting mixture contains 0.5 to 1.5 equivalents, preferably 0.7 to 1.2 equivalents of acid anhydride with respect to 1 equivalent of the epoxy group in the epoxy resin.

If the amount of the acid anhydride curing agent is smaller than 0.5 equivalents, the hue after curing is worsened. If the amount of the acid anhydride curing agent is larger than 1.5 equivalents, there is a tendency toward lowering of moisture resistance. Also when another curing agent is used singly or a combination of two or more kinds of curing agents is used, the amount of the curing agent used can be decided in accordance with the aforementioned equivalent ratio.

Examples of the curing accelerator include tertiary amine, imidazole, quaternary ammonium salt, organometallic salt, a phosphoric compound, and a urea compound. Among these, tertiary amine, imidazole or a phosphoric compound is especially preferred.

These may be used singly or as a combination of two or more kinds. The curing accelerator may be preferably mixed with the epoxy resin so that the resulting mixture contains 0.05 to 7 parts by weight, preferably 0.2 to 3 parts by weight of the curing accelerator with respect to 100 parts by weight of the epoxy resin. If the amount of the curing accelerator is smaller than 0.05 parts by weight, a sufficient curing acceleration effect cannot be obtained. If the amount of the curing accelerator is larger than 7 parts by weight, there is a possibility that the cured resin will be discolored.

Examples of the age resister include heretofore known compounds such as a phenol compound, an amine compound, an organosulfur compound, and a phosphine compound.

Any one of heretofore known compounds such as glycol, silicone, and alcohol can be used as the modifying agent.

The surfactant is mixed so that the film surface can be smoothened when the epoxy resin is molded while brought into contact with air by a flow casting method. Examples of the surface active agent used for this purpose include a silicone resin, an acrylic resin, and a fluororesin. Especially, a silicone resin is preferred.

In the transparent laminate 1, the transparent relaxing layer 12 is provided for relaxing forcing stress due to pen-input to prevent image smearing and for giving moderate elastic deformability due to pen-input to make drawing characteristic of the pen good and furthermore for relaxing external impact. The dynamic storage modulus G′ of the transparent relaxing layer 12 at 20° C. is selected to be preferably not higher than 1×10⁷ Pa, further preferably in a range of from 1×10³ to 7×10⁶ Pa.

If the dynamic storage modulus G′ is higher than 1×10⁷ Pa, the feeling of writing is worsened and characteristic of preventing the crack of the image display panel due to impact is lowered. If the dynamic storage modulus G′ is too low, the transparent relaxing layer 12 is too soft to prevent image smearing and is hard to be processed at the time of punching or cutting for producing a film. Moreover, there is a problem that edge portions of the transparent relaxing layer 12 may extrude. It is therefore preferable that the dynamic storage modulus G′ is not lower than 1×10³ Pa.

Incidentally, the “moderate elastic deformability” means such a property that the contact portion sinks inward to a depth of 20 to 100 μm when the input pen M is brought into contact under a load of 300 g, and that the contact portion is restored to its original state rapidly when the load is removed.

If the sinking depth is smaller than 20 μm, the feeling of writing is poor as if a character were drawn on a hard board. If the sinking depth is contrariwise larger than 100 μm, the touch panel sinks too deeply to write a character on the touch panel. Moreover, if the contact portion is not restored to its original state when the load is removed, it is impossible to repeat writing on the same portion.

A polyacetal resin is mainly used as the material of the input pen M. The input pen M has a pen point shape with a radius of about 0.8 mm. When the contact portion sinks inward to a depth in the aforementioned specific range relative to the input pen M, a good feeling of writing can be obtained. This is considered to be the same effect as in the case where a character is written with a ball point pen etc. on a sheet of paper placed on a desk mat to obtain a good feeling of writing compared with the case where a character is written with a ball point pen etc. on a sheet of paper directly placed on a hard desk.

The thickness of the transparent relaxing layer 12 is selected to be in a range of from 0.2 to 2 mm. If the thickness is smaller than 0.2 mm, image smearing due pen-input may occur, the writing characteristic of the pen may be lowered, and the liquid crystal panel may be easily broken by impact. If the thickness is larger than 2 mm, image degradation may be easily caused by the problem of parallax. Especially preferably, the thickness is not larger than 1.5 mm.

Any material can be used widely as the material of the transparent relaxing layer 12 as long as it has the aforementioned thickness, excellent transparency (transmittance of 60% or higher) and the aforementioned dynamic storage modulus G′.

Examples include: thermoplastic resins such as an ionomer resin prepared by crosslinking molecules of an ethylene-methacrylate copolymer with metal ions (Na⁺, Zn²⁺, etc.), an ethylene-vinyl acetate copolymer (EVA), a polyvinyl chloride resin, an ethylene-acrylate copolymer, polyethylene (PE), polypropylene (PP), a polyamide resin, a polybutyral resin, and a polystyrene resin; and thermoplastic elastomers exhibiting rubber elasticity. Examples of the thermoplastic elastomers exhibiting rubber elasticity include: polymers such as a polystyrene polymer, a polyolefin polymer, a polydiene polymer, a vinyl chloride polymer, a polyurethane polymer, a polyester polymer, a polyamide polymer, a fluorine polymer, a chlorinated polyethylene polymer, and a polynorbornene polymer; polystyrene-polyolefin copolymers; (hydrogenated) polystyrene-butadiene copolymers; and polystyrene-vinyl polyisoprene copolymers. A blend of the polyolefin such as PE or PP and the thermoplastic elastomer may be also used.

A laminate such as polyolefin (PP, PE, etc.)/thermoplastic resin (EVA)/polyolefin, polyolefin (PP or PE)/polyolefin+thermoplastic elastomer/polyolefin (PP or PE), or PP/PE/PP, a laminate prepared by changing the blend ratio of polyolefin+thermoplastic elastomer, a laminate prepared by blending the thermoplastic elastomer with polyolefin, or the like, may be also used.

It is further preferable that the transparent relaxing layer 12 is made of an adhesive. In this case, as shown in the drawing, the adhesiveness of the adhesive can be used for direct sticking onto the liquid crystal panel 2 directly (through the optical film 3) to attain simplification of the apparatus configuration.

Any material can be used as the adhesive as long as it has excellent transparency and the aforementioned dynamic storage modulus G′. Various adhesives such as a thermally crosslinked type, an optically (ultraviolet ray, electron beam) crosslinked type, etc. can be used. Examples of the adhesive include an acrylic adhesive, a rubber adhesive, a polyester adhesive, and a silicone adhesive. An acrylic adhesive is especially preferred from the point of view of transparency and durability.

The acrylic adhesive is prepared in such a manner that various additives such as an anti-oxidant, an ultraviolet absorbing agent, a tackifier, a plasticizer, and a light-scattering agent are suitably mixed with an acrylic polymer. An inorganic filler etc. may be added to thereby form a composite. As occasion demands, the acrylic adhesive may be crosslinked to adjust adhesiveness and heat resistance.

The acrylic polymer is prepared in such a manner that (meth)acrylic alkyl ester as a main component is polymerized by an ordinary method in the condition that a copolymerizable modifying monomer is added to the main component in order to improve physical properties such as optical characteristic and heat resistance as occasion demands. The amount of the (meth)acrylic alkyl ester used is selected to be in a range of from 60 to 100% by weight, preferably in a range of from 85 to 100% by weight. The amount of the modifying monomer used is selected to be in a range of from 40 to 0% by weight, preferably in a range of from 15 to 0% by weight. When such a monomer composition is used, a good result can be obtained in terms of impact relaxing characteristic or the like.

Straight-chain or branched-chain (meth)acrylic alkyl ester having alkyl groups having 1 to 18 carbon atoms, preferably 4 to 12 carbon atoms, is used as the (meth)acrylic alkyl ester. Specific examples of the (meth)acrylic alkyl ester include butyl (meth)acrylate, isobutyl (meth)acrylate, hexyl (meth)acrylate, 2-ethylhexyl (meth)acrylate, isooctyl (meth)acrylate, isononyl (meth)acrylate, allyl (meth)acrylate, lauryl (meth)acrylate, and stearyl (meth)acrylate. One kind or two or more kinds selected from these may be used.

Examples of the copolymerizable modifying monomer include: carboxyl group-containing monomers such as acrylic acid, methacrylic acid, carboxyethyl acrylate, carboxypentyl acrylate, itaconic acid, maleic acid, fumaric acid, and crotonic acid; acid anhydride monomers such as maleic anhydride, and itaconic anhydride; sulfonic group-containing monomers such as styrene sulfonate, allyl sulfonate, 2-(meth)acrylamide-2-methylpropane sulfonate, (meth)acrylamidepropane sulfonate, sulfopropyl (meth)acrylate, and (meth)acryloyloxynaphthalene sulfonate; and phosphoric group-containing monomers such as 2-hydroxyethylacryloyl phosphate.

Further examples of the modifying monomer which can be used include: (N-substituted) amide monomers such as (meth)acrylamide, N,N-dimethyl(meth)acrylamide, N-butyl(meth)acrylamide, N-methylol(meth)acrylamide, and N-methylolpropane(meth)acrylamide; alkylaminoalkyl (meth)acrylate monomers such as aminoethyl (meth)acrylate, N,N-dimethylaminoethyl (meth)acrylate, and t-butylaminoethyl (meth)acrylate; alkoxyalkyl (meth)acrylate monomers such as methoxyethyl (meth)acrylate, and ethoxyethyl (meth)acrylate; and succinimide monomers such as N-(meth)acryloyloxymethylene succinimide, N-(meth)acryloyl-6-oxyhexamethylene succinimide, and N-(meth)acryloyl-8-oxyoctamethylene succinimide.

Further examples of the modifying monomer which can be used include: vinyl monomers such as vinyl acetate, vinyl propionate, N-vinyl pyrolidone, methylvinyl pyrolidone, vinyl pyridine, vinyl piperidone, vinyl pyrimidine, vinyl piperazine, vinyl pyrazine, vinyl pyrrole, vinyl imidazole, vinyl oxazole, vinyl morpholine, N-vinylcarboxylic amide, styrene, α-methylstyrene, and N-vinyl caprolactam; cyanoacrylate monomers such as acrylonitrile, and methacrylonitrile; epoxy group-containing acrylic monomers such as glycidine (meth)acrylate; glycol acrylic ester monomers such as polyethylene glycol (meth)acrylate, polypropylene glycol (meth)acrylate, methoxy polyethylene glycol (meth)acrylate, and methoxy polypropylene glycol (meth)acrylate; acrylic ester monomers such as tetrahydrofurfuryl (meth)acrylate, fluorine (meth)acrylate, silicone (meth)acrylate, and 2-methoxyethyl acrylate.

The monomer can be polymerized by a known polymerization method such as solution polymerization, emulsion polymerization, bulk polymerization, suspension polymerization, etc. On this occasion, a polymerization initiator such as a thermal polymerization initiator or a photopolymerization initiator is used in accordance with the polymerization method.

The amount of the polymerization initiator used is selected suitably in a range of from 0.005 to 5 parts by weight per 100 parts by weight of the monomer in accordance with the kind of the polymerization initiator. The amount of the photopolymerization initiator is selected to be in a range of from 0.005 to 1 part by weight, preferably in a range of from 0.05 to 0.5 parts by weight. If the amount of the photopolymerization initiator is too small, voids occur easily in an adhesive interface because a large amount of unreacted monomer remains after the start of the photopolymerization. If the amount of the photopolymerization initiator is too large, yellow discoloration is caused easily because a part of the photopolymerization initiator remains during the start of the photopolymerization. For the same reason as described above, the amount of the thermal polymerization initiator is selected to be in a range of from 0.01 to 5 parts by weight, preferably in a range of from 0.05 to 3 parts by weight.

Examples of the photopolymerization initiator include: acetophenone compounds such as 4-(2-hydroxyethoxy)phenyl(2-hydroxy-2-propyl)ketone, α-hydroxy-α,α-dimethylacetophenone, methoxyacetophenone, 2,2-dimethoxy-2-phenylacetophenone, 2,2-diethoxyacetophenone, 1-hydroxycyclohexylphenylketone, and 2-methyl-1-[4-(methylthio)-phenyl]-2-morpholinopropane-1; benzoin ether compounds such as benzoin ethyl ether, benzoin isopropyl ether, and anizoin methyl ether; α-ketol compounds such as 2-methyl-2-hydroxypropiophenone; ketal compounds such as benzyl dimethyl ketal; aromatic sulfonyl chloride compounds such as 2-naphthalene sulfonyl chloride; light-activated oxime compounds such as 1-phenone-1,1-propanedione-2-(o-ethoxycarbonyl)oxime; and benzophenone compounds such as benzophenone, benzoyl benzoate, and 3,3′-dimethyl-4-methoxybenzophenone.

Examples of the thermal polymerization initiator include organic peroxides such as benzoyl peroxide, t-butyl perbenzonate, cumene hydroperoxide, diisopropyl peroxydicarbonate, di-n-propyl peroxydicarbonate, di(2-ethoxyethyl) peroxydicarbonate, t-butyl peroxyneodecanoate, t-butyl peroxypivalate, (3,5,5-trimethylhexanoyl) peroxide, dipropionyl peroxide, and diacetyl peroxide.

Further examples include azo compounds such as 2,2′-azobisisobutylonitrile, 2,2′-azobis(2-methylbutylonitrile), 1,1′-azobis(cyclohexane-1-carbonitrile), 2,2′-azobis(2,4-dimethylvaleronitrile), 2,2′-azobis(2,4-dimethyl-4-methoxyvaleronitrile), dimethyl 2,2′-azobis(2-methylpropionate), 4,4′-azobis(4-cyanovalerate), 2,2′-azobis(2-hydroxymethylpropionitrile), and 2,2′-azobis[2-(2-imidazoline-2-yl)propane].

As occasion demands, polyfunctional (meth)acrylate having two or more (meth)acryloyl groups in a molecule may be added as a crosslinking agent (internal bridging agent) to improve the cohesion etc. of the transparent relaxing layer to thereby increase shear strength during the polymerization. Specific examples include hexadiol di(meth)acrylate, (poly)ethylene glycol di(meth)acrylate, (poly)propylene glycol di(meth)acrylate, neopentyl glycol di(meth)acrylate, pentaerythritol di(meth)acrylate, trimethylolpropane tri(meth)acrylate, pentaerythritol tri(meth)acrylate, dipentaerythritol hexa(meth)acrylate, epoxy acrylate, polyester acrylate, and urethane acrylate.

The amount of the polyfunctional (meth)acrylate used is selected to be not smaller than 0.01 parts by weight, preferably in a range of from 0.05 to 5 parts by weight per 100 parts by weight of the monomer. When two functions are provided, the amount of the polyfunctional (meth)acrylate is selected to be relatively large. When three or more functions are provided, the amount of the polyfunctional (meth)acrylate is selected to be relatively small. If the amount of the polyfunctional (meth)acrylate is too small, voids occur easily in an adhesive interface because the degree of crosslinking after the photopolymerization is low. If the amount of the polyfunctional (meth)acrylate is too large, swelling etc. occurs easily because the adhesiveness is lowered.

The polymerization is performed by either photopolymerization method using ultraviolet rays or thermal polymerization method in accordance with the kind of the polymerization initiator. The photopolymerization method is especially preferred from the point of view of processability to the transparent relaxing layer, adhesiveness, etc. It is preferable that the photopolymerization method is performed in an oxygen-free atmosphere replaced by inert gas such as nitrogen gas or in a state shielded from air by an ultraviolet-transmissive film.

In the photopolymerization method, the ultraviolet rays are electromagnetic radiations in a wavelength range of from about 180 to about 460 nm. The ultraviolet rays may be replaced by electromagnetic radiations longer or shorter than this wavelength range. An irradiation device such as a mercury arc lamp, a carbon arc lamp, a low-pressure mercury lamp, a middle/high-pressure mercury lamp, a metal halide lamp, a chemical lamp, a black light lamp, or the like, is used as an ultraviolet-ray source.

The intensity of the ultraviolet rays can be set suitably on the basis of the distance to a subject of irradiation and adjustment of the voltage. It is generally preferable that integrated light intensity of from 0.5 to 10 J/cm² is used in view of the irradiation time (production efficiency). There is a possibility that the adhesive in the transparent relaxing layer may be undulated by heat of the polymerization. When the adhesive is cooled during the photopolymerization, the undulation of the adhesive can be suppressed.

As occasion demands, one kind or two or more kinds of plasticizers good in transparency may be mixed with the transparent relaxing layer 12. In the case of the aforementioned acrylic adhesive, the amount of the plasticizer mixed is selected to be in a range of from 5 to 300 parts by weight, preferably in a range of from 10 to 200 parts by weight per 100 parts by weight of the monomer (accordingly, the acrylic polymer).

Examples of the plasticizer include: phthalic compounds such as dimethyl phthalate, diethyl phthalate, dibutyl phthalate, diheptyl phthalate, di-2-ethylhexyl phthalate, diisononyl phthalate, diisodecyl phthalate, dibutylbenzyl phthalate, dioctyl phthalate, and butylphthalylbutyl glycolate; adipic compounds such as diisobutyl adipate, diisononyl adipate, diisodecyl adipate, and dibutoxyethyl adipate; sebacic compounds such as dibutyl sebacate, and di-2-ethylhexyl sebacate; phosphoric compounds such as triethylene phosphate, triphenyl phosphate, tricresyl phosphate, trixylenyl phosphate, and cresylphenyl phosphate; aliphatic compounds such as dioctyl sebacate, and methyl acetylricinoleate; epoxy compounds such as diisodecyl-4,5-epoxy tetrahydrophthalate; and trimellitic compounds such as tributyl trimellitate, tri-2-ethylhexyl trimellitate, tri-n-octyl trimellitate, and triisodecyl trimellitate. Further examples which can be used include butyl oleate, chlorinated paraffin, polyoxyalkylene glycol such as polypropylene glycol, and polytetramethylene glycol. Further examples which can be used include polybutene, and polyisobutylene.

Suitable additives may be mixed with the transparent relaxing layer 12 if transparent is not spoiled. Examples of the additives include: materials having characteristic of absorbing neon light (570 to 590 nm) to improve color purity; coloring matter such as pigments or dyes for correcting the color of the liquid crystal; a tackifier; an anti-oxidant; an age resister; an ultraviolet absorbing agent, a silane coupling agent, resins such as natural resins or synthetic resins; acrylic oligomer; and glass fiber and glass beads. Fine particles may be contained to give light-scattering characteristic.

The transparent relaxing layer 12 may be made of a polymer composite material using organic lamellar clay minerals. In this case, when a transparent high-molecular resin or rubber such as a polyurethane resin, a polyether resin, an acrylic resin, natural rubber, butyl rubber, etc. having a dynamic storage modulus of not higher than 6×10⁶ Pa (practically, 1×10³ to 1×10⁵ Pa) at 20° C. is used as a main material capable of containing organic lamellar clay minerals dispersed therein and capable of being molded into a film, pen-input and external impact can be relaxed well to obtain a good result for preventing image smearing on the image display panel and preventing the crack of the image display panel. An acrylic high-molecular resin is especially useful from the point of view of heat resistance, moisture resistance reliability, transparency, processability, affinity to organic lamellar clay minerals, and so on.

The transparent laminate according to the invention may be used in a resistive film type pen-input image display device. That is, FIGS. 1 and 2 show the case where the transparent laminate is used in an electromagnetic induction type pen-input image display device. The transparent laminate may be used in a resistive film type pen-input image display device in such a manner that a pair of transparent electrically conductive layers facing each other with separation of a predetermined distance are provided in any portion between the surface-treated layer and the transparent relaxing layer.

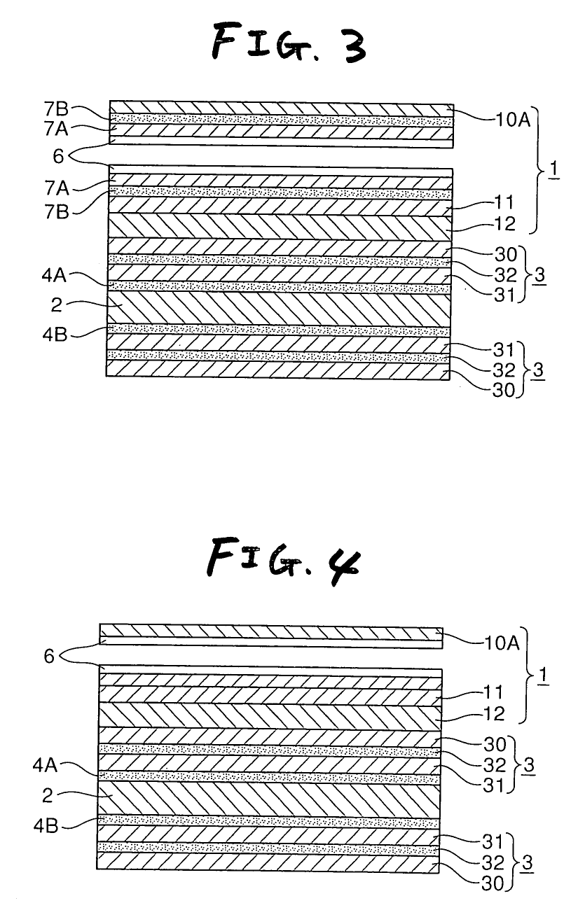

FIG. 3 shows this case. A pair of transparent electrically conductive films each made of a transparent electrically conductive layer 6 provided on a single surface of a transparent polymer film 7A are disposed between a surface-treated film 10A and a transparent rigid layer 11 so that the respective transparent electrically conductive layer 6 sides face each other through a spacer. Thus, a transparent laminate 1 is formed. When the pair of transparent electrically conductive films are arranged, surfaces of the transparent polymer films 7A opposite to the surfaces on which the transparent electrically conductive layers 6 are formed respectively are adhesively laminated on the surface-treated film 10A and the transparent rigid layer 11 through transparent adhesive layers 7B respectively.

Incidentally, other constituent members than the aforementioned members in FIG. 3 are the same as those in FIG. 1 and are referred to by numerals the same as those in FIG. 1 for the sake of omission of duplicated description.

Although this example shows the case where the pair of transparent electrically conductive films are disposed between the surface-treated film 10A and the transparent rigid layer 11, changes of the embodiment may be made. For example, the pair of transparent electrically conductive films may be disposed between the transparent rigid layer 11 and the transparent relaxing layer 12.

Each of the transparent electrically conductive films is formed so that the same plastic film as used in the surface-treated film 10A or the transparent rigid layer 11 is used as the transparent polymer film 7A. A plastic film prepared in such a manner that the thermal shrinkage difference after heating at 150° C. for 30 minutes is not larger than 0.2% in both MD and TD directions is preferred from the point of view of preventing deformation after the heating process.

The thickness of the transparent polymer film 7A can be decided suitably but is selected to be generally in a range of from 3 to 300 μm, preferably in a range of from 5 to 250 μm, especially preferably in a range of from 10 to 200 μm from the point of view of production efficiency at the time of forming the panel, performance, and so on.

Examples of the material for forming the transparent electrically conductive layer 6 include: metal such as gold, silver, platinum, palladium, rhodium, indium, copper, aluminum, nickel, chromium, titanium, iron, cobalt, tin, and alloys of these; metal oxide such as indium oxide, tin oxide, titanium oxide, cadmium oxide, and composite oxide of these; and metal compounds such as copper iodide. Composite oxide of indium and tin (hereinafter referred to as ITO) is especially preferred.

The transparent electrically conductive layer 6 can be formed by a suitable thin film-forming method such as a vacuum vapor deposition method, a sputtering method, a spray thermal decomposition method, an ion-plating method, a chemical plating method, an electroplating method, or a combination of these. A vacuum vapor deposition method or a sputtering method is preferred from the point of view of the film-forming speed, facilitation of forming a large-area film, production efficiency, and so on.

The thickness of the transparent electrically conductive layer 6 can be decided suitably in accordance with the purpose of use. Particularly an electrode having a surface resistivity of not higher than 10³ Ω/□ is preferred as a touch panel electrode. Generally an electrode having a surface resistivity of not higher than 10⁹ Ω/□ is preferred. Such surface resistivity can be generally achieved when the thickness of the transparent electrically conductive layer 6 is selected to be in a range of from 30 to 600 Å in the case where it is a metal electrically conductive layer or when thickness of the transparent electrically conductive layer 6 is selected to be in a range of from 80 to 5,000 Å in the case where it is a metal oxide electrically conductive layer.

In the transparent electrically conductive film, the transparent electrically conductive layer 6 may be directly formed on the transparent polymer film 7A. Alternatively, an undercoat layer may be interposed between the transparent polymer film 7A and the transparent electrically conductive layer 6. The formation of the undercoat layer can improve the adhesion of the transparent electrically conductive layer 6 to the transparent polymer film 7A to thereby prevent the transparent electrically conductive layer 6 from being peeled.

Examples of the material for forming the undercoat layer include: resins such as an acrylic resin, an urethane resin, and an epoxy resin; and hydrolyzed organosilicon compounds. The undercoat layer made of any one of these materials can be formed in such a manner that a high-molecular film is coated with a coating solution of a desired composition by a doctor knife, a bar coater, an engraved-roll coater, a curtain coater, a knife coater, or the like.

An undercoat layer made of a metal selected from the group consisting of silicon, titanium, tin and zinc, an undercoat layer made of oxide of any one of these metals or an undercoat layer made of an alloy of ones of these metals may be also used. Examples of the metal oxide for forming the undercoat layer include silicon oxide, titanium oxide, tin oxide, tin oxide-hafnium oxide, silicon oxide-tin oxide, zinc oxide-tin oxide, and tin oxide-titanium oxide. A vacuum thin film-forming technique such as a sputtering method, a resistance vapor deposition method, or an electron beam vapor deposition method can be used for forming the undercoat layer. The undercoat layer may be formed as a single layer or a combination of two or more layers.

Incidentally, when the transparent electrically conductive layer 6 is to be directly formed on the transparent polymer film 7A or the undercoat layer is to be formed, a suitable pre-treatment such as a corona discharge treatment, an ultraviolet irradiation treatment, a plasma treatment or a sputter-etching treatment may be applied to the film surface of the transparent polymer film 7A to improve the adhesion of the transparent electrically conductive layer 6 or the undercoat layer.

It is preferable that the same adhesive as used in the transparent relaxing layer is used in the transparent adhesive layers 7B by which surfaces of (the transparent polymer films 7A for forming) the transparent electrically conductive films opposite to the surfaces on which the transparent electrically conductive layers 6 are formed respectively are adhesively laminated on the surface-treated film 10A and the transparent rigid layer 11 respectively. Particularly an adhesive layer having an elastic coefficient of from 1×10⁵ to 1×10⁷ dyn/cm² and having a thickness of 1 μm or larger, preferably in a range of from 5 to 500 μm is preferred.

The transparent laminate 1 shown in FIG. 3 is formed so that a pair of transparent electrically conductive films each having a transparent electrically conductive layer 6 formed on a single surface of a transparent polymer film 7A are disposed between a surface-treated film 10A and a transparent rigid layer 11. Besides this configuration, configuration may be made so that a pair of films each prepared in such a manner that a transparent electrically conductive layer 6 is directly formed on a non-treated surface of a surface-treated film 10A are disposed on a transparent rigid layer 11 through a spacer, as will be described in the following embodiment.

As shown in FIG. 4, configuration may be made so that a transparent electrically conductive layer 6 directly formed on a non-treated surface of a surface-treated film 10A and another transparent electrically conductive layer 6 directly formed on a transparent rigid layer 11 are disposed on a transparent relaxing layer 12 so as to face each other through a spacer. In this embodiment, use of the aforementioned transparent adhesive layers 7B can be omitted. Incidentally, the other constituent members than the aforementioned members in FIG. 4 are the same as those in FIG. 1 and referred to by numerals the same as those in FIG. 1 for the sake of omission of duplicated description.

The transparent laminate 1 includes the surface-treated layer 10 (surface-treated film 10A), the transparent rigid layer 11 and the transparent relaxing layer 12 as essential constituent members. In the case of a resistive film type, the transparent laminate 1 further includes a pair of transparent electrically conductive layers 6 disposed in any portion between the surface-treated layer 11 and the transparent relaxing layer 12 so as to face each other with separation of a predetermined distance. For example, the respective layers are laminated as shown in FIGS. 1 to 4. It is preferable that the total thickness of the resulting sheet is equal to or smaller than that of the conventional protective sheet.

Examples of the polarizing plate 30 in each optical film 3 include: a sheet prepared by adsorbing iodine and/or dichromatic dye onto a hydrophilic high-molecular film such as a polyvinyl alcohol film, a partially formalized polyvinyl alcohol film or an ethylene-vinyl acetate copolymer saponified film and drawing the hydrophilic high-molecular film; and a polyene oriented film such as dehydrated polyvinyl alcohol or dehydrochlorinated polyvinyl chloride. The thickness of the polarizing plate 30 is generally in a range of from 5 to 80 μm but is not particularly limited thereto.

Generally, the polarizing plate 30 is used in a state in which a transparent protective film is laminated to one or each of surfaces of the aforementioned polarizer. A film excellent in transparency, mechanical strength, heat stability, moisture sealability and isotropy is preferably used as the transparent protective film.

Specific examples of the material of the film include: polyester polymers such as polyethylene terephthalate, and polyethylene naphthalate; cellulose polymers such as diacetyl cellulose, and triacetyl cellulose; acrylic polymers such as polymethyl (meth)acrylate; styrene polymers such as polystyrene, and acrylonitrile-styrene copolymer; polycarbonate polymers; polyolefin polymers such as polyethylene, polypropylene, polyolefin having a cyclo or norbornene structure, and ethylene-propylene copolymer; vinyl chloride polymers; Nylon; aromatic polyamide polymers; imide polymers; sulfone polymers; polyether-sulfone polymers; polyether-ether-ketone polymers; vinylidene chloride polymers; vinyl alcohol polymers; vinyl butyral polymers; allylate polymers; polyoxymethylene polymers; epoxy polymers; and bends of these polymers.

A film made of a cellulose polymer is preferably used as the transparent protective film. The thickness of the transparent protective film is not particularly limited but is selected to be generally not larger than 500 μm, preferably in a range of from 1 to 300 μm, further preferably in a range of from 5 to 200 μm.

An isocyanate adhesive, a polyvinyl alcohol adhesive, a gelatin adhesive, a vinyl latex adhesive, a water type proester, or the like, is used for sticking the polarizing plate to the transparent protective film.

The retardation plate 31 in each optical film 3 is used in a state in which the polarizing plate 30 is laminated on the retardation plate 31 for the purpose of converting linearly polarized light into elliptically or circularly polarized light, converting elliptically or circularly polarized light into linearly polarized light or changing the direction of polarization of linearly polarized light.

A quarter-wave plate (λ/4 plate) is used particularly as a retardation plate for converting linearly polarized light into circularly polarized light or converting circularly polarized light into linearly polarized light. A half-wave plate is used as a retardation plate for changing the direction of polarization of linearly polarized light.

When the retardation plate 31 is laminated on the polarizing plate 30 to form an elliptically polarizing plate, the elliptically polarizing plate 31 can be used effectively for compensating coloring caused by birefringence of an STN liquid crystal display device to achieve colorless monochrome display. Three-dimensional refractive indices are preferably controlled because coloring generated by oblique vision of a screen of a liquid crystal display device can be compensated.

When the retardation plate 31 is laminated on the polarizing plate 30 to form a circularly polarizing plate, the circularly polarizing plate can be used, for example, for adjusting the color tone of an image on a reflective liquid crystal display device of the type for displaying a color image and further has an anti-reflection function.

The retardation plate 31 is not particularly limited. Examples of the retardation plate 31 include: a birefringent film prepared by uniaxially or biaxially stretching a known high-molecular material; an oriented film of a liquid crystal polymer; and an oriented layer of a liquid crystal polymer supported by a film. The thickness of the retardation plate is not particularly limited but is generally selected to be in a range of from 20 to 150 μm.

Incidentally, the retardation plate 31 may have a suitable phase difference in accordance with the purpose of use. For example, the retardation plate 31 is provided for the purpose of compensating vision of coloring caused by birefringence of any kind of wavelength sheet or liquid crystal layer. The retardation plate 31 may be provided as a combination of two or more kinds of retardation plates which are laminated so that optical characteristic such as phase difference is controlled.

The retardation plate 31 may be made of a visual compensation film (optically compensatory film). The visual compensating film is a film for widening the view field so that an image can be viewed relatively sharply even in the case where a screen of a liquid crystal display device is observed not perpendicularly but slightly obliquely to the screen. The visual compensating retardation plate is made of a ratardation film, an oriented film of a liquid crystal polymer or the like, a film prepared by supporting an oriented layer of a liquid crystal polymer or the like on a transparent film base, or the like.

A polymer film stretched uniaxially in a planar direction and having birefringence is used as a general retardation plate. On the contrary, a biaxially stretched film such as a polymer film stretched biaxially in a planar direction and having birefringence or a polymer or gradient oriented film stretched uniaxially in a planar direction, stretched in a direction of thickness and having birefringence with the refractive index controlled in the direction of thickness is used as a retardation plate used for the visual compensating film. The gradient oriented film is not particularly limited but a film according to a known technique can be used as the gradient oriented film. From the point of view of achieving a wide view angle for vision and so on, an optical compensating retardation plate prepared by supporting an optical anisotropic layer made of an oriented layer of a liquid crystal polymer, especially a gradient oriented layer of a discotic liquid crystal polymer on a triacetyl cellulose film may be used preferably.

In each optical film 3, the transparent adhesive layer 32 used for laminating the retardation plate (optically compensatory plate) 31 on the polarizing plate 30 may be made of any known adhesive such as an acrylic adhesive or a rubber adhesive having transparency. The transparent adhesive layer 4 A for sticking the optical film 3 onto the visual surface side of the liquid crystal panel 2 and the transparent adhesive layer 4 B for sticking the other optical film 3 onto the rear surface side of the liquid crystal panel 2 may be made of the same adhesive as described above.

Although each of the aforementioned optical films 3 is formed in such a manner that the retardation plate (optically compensatory plate) 31 is laminated on the polarizing plate 30, any optical layer such as a reflection plate, a semi-transmissive plate, a brightness-enhancement film, etc. used for forming a liquid crystal display device may be used as another optical layer. The other optical layer may be constituted by a single layer or a combination of two or more layers laminated on the polarizing plate 30.

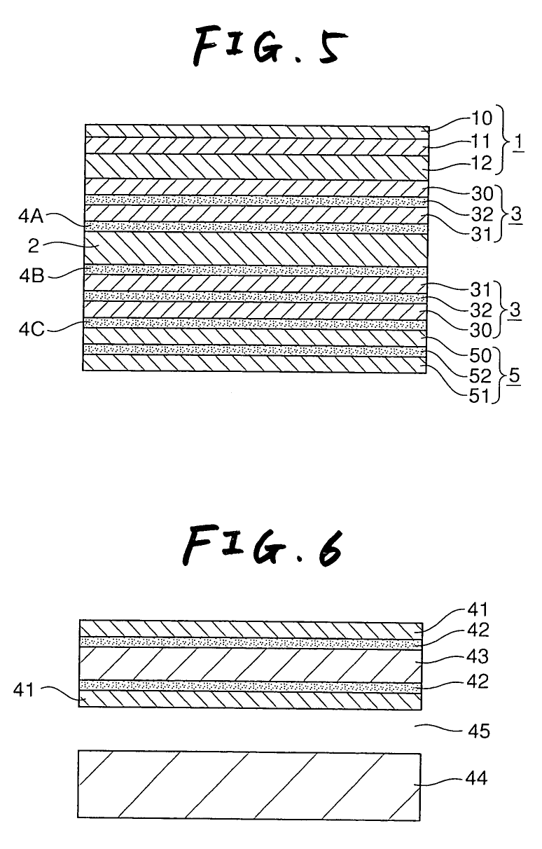

FIG. 5 shows the embodiment where a brightness-enhancement film 5 prepared by sticking a quarter-wave plate 50 and a cholesteric liquid crystal layer 51 to each other through a transparent adhesive layer 52 is used in addition to the optical films 3. The brightness-enhancement film 5 is laminated on the polarizing plate 30 of the optical film 3 located on the rear surface side of the liquid crystal panel 2, through a transparent adhesive layer 4C.

The transparent adhesive layer 52 and the transparent adhesive layer 4C may be made of the same known adhesive as described above. In FIG. 5, the other constituent members are the same as those in FIG. 2 and referred to by numerals the same as those in FIG. 2 for the sake of omission of duplicated description.

The brightness-enhancement film exhibits characteristic of reflecting linearly polarized light having a predetermined axis of polarization or circularly polarized light having a predetermined direction but transmitting the other part of light when natural light from a backlight unit of a liquid crystal display device or the like or by reflection on the rear side is incident on the brightness-enhancement film. When the brightness-enhancement film is laminated on the polarizing plate, transmitted light in a predetermined polarized state is, obtained while light in the other state than the predetermined polarized state is not transmitted but reflected when light from a light source of the backlight unit is incident on the combination of the brightness-enhancement film and the polarizing plate.

The light reflected by the brightness-enhancement film surface is inverted through a reflection layer (not shown) or the like provided on the rear side of the brightness-enhancement film so that the inverted light is made incident on the brightness-enhancement film again. Part or all of the light is transmitted as light in the predetermined polarized state to attain increase in the intensity of light transmitted through the brightness-enhancement film. At the same time, polarized light hardly absorbed to the polarizer is supplied to attain increase in the optical length of light allowed to be used in the liquid crystal display device or the like. In this manner, luminance is enhanced.

A diffusing plate may be provided between the brightness-enhancement film and the reflection layer or the like. Although the light of the polarized state reflected by the brightness-enhancement film goes toward the reflection layer, the diffusing plate provided thus diffuses the transmitted light evenly and simultaneously eliminates the polarized state to a non-polarized state. That is, the diffusing plate restores the polarized light to its original natural light. The light of the non-polarized state, that is, of the natural light state goes toward the reflection layer or the like. The light is reflected through the reflection layer and transmitted through the diffusing plate again so as to be made incident on the brightness-enhancement film again. This operation is repeated.

In this manner, when the diffusing plate for restoring the polarized light to its original natural light state is provided between the brightness-enhancement film and the reflection film or the like, unevenness in brightness of the display screen can be reduced while brightness of the display screen can be retained. Thus, a uniform and bright screen can be provided. When the aforementioned diffusing plate is provided, the number of repetitions in reflection of the initial incident light is increased moderately. This function is combined with the diffusing plate function, so that a uniform and bright display screen can be provided.

The brightness-enhancement film is not limited to the drawing. Any suitable film can be used as the brightness-enhancement film. Examples of the brightness-enhancement film include: a film exhibiting characteristic of transmitting linearly polarized light having a predetermined axis of polarization but reflecting the other light, such as a multi-layer thin film of dielectrics or a multi-layer laminate of thin films different in refractive anisotropy; and a film exhibiting characteristic of reflecting either left-handed or right-handed circularly polarized light but transmitting the other light, such as an oriented film of a cholesteric liquid crystal polymer or a film prepared by supporting an oriented layer of the liquid crystal on a film base.

In a brightness-enhancement film of the type of transmitting linearly polarized light having a predetermined axis of polarization, the transmitted light can be made incident on the polarizing plate directly while the axis of polarization of the light is adjusted. As a result, the light can be transmitted through the polarizing plate efficiently while absorption loss due to the polarizing plate can be suppressed. In a brightness-enhancement film of the type of transmitting circularly polarized light such as a cholesteric liquid crystal layer, circularly polarized light can be made incident on the polarizer directly but it is preferable from the point of view of suppressing absorption loss that circularly polarized light is converted into linearly polarized light through a retardation plate to make the linearly polarized light incident on the polarizing plate. When a quarter-wave plate is used as the retardation plate, circularly polarized light can be converted into linearly polarized light.

For example, a retardation plate serving as a quarter-wave plate in a wide wavelength range such as a visual light range can be obtained in such a manner that a retardation plate layer serving as a retardation plate exhibiting the other retardation characteristic, for example, a retardation layer serving as a half-wave plate is superposed on a retardation plate serving as a quarter-wave plate for monochromatic light with a wavelength of 550 nm. The retardation plate disposed between the polarizing plate and the brightness-enhancement film may be made of one retardation layer or a combination of two or more retardation layers.

When the cholesteric liquid crystal layer is provided as a structure in which two layers or three or more layers different in reflection wavelength are superposed in combination, the cholesteric liquid crystal layer can be obtained as a layer reflecting circularly polarized light in a wide wavelength range such as a visible light range. As a result, circularly polarized light transmitted in a wide wavelength range can be obtained.

The polarizing plate may be provided as a laminate of a polarizing plate and two optical layers or three or more optical layers, as represented by the aforementioned polarized light separating plate. The polarizing plate may be provided as a reflective circularly polarizing plate which is a combination of a reflective polarizing plate and a retardation plate or as a semi-transmissive elliptically polarizing plate which is a combination of a semi-transmissive polarizing plate and a retardation plate.

Incidentally, when various kinds of optical layers need to be laminated on the polarizing plate, the optical layers can be laminated successively and respectively in a process of production of a liquid crystal display device or the like, but it is further preferable that the optical layers are laminated as an optical film in advance because the optical film is excellent in quality stability and processability.

For lamination of the polarizing plate and various kinds of optical layers, the optical axes of these can be disposed at suitable angles in accordance with the target retardation characteristic etc.

As described above, the pen-input image display device according to the invention is characterized in that the transparent laminate 1 is directly laminated onto the visual surface side (pen-input side) of the liquid crystal panel 2 in the condition that the transparent relaxing layer 12 is disposed inward after the optical films 3, etc. are arranged on the liquid crystal panel 2. When pen-input is made on the surface of the transparent laminate 1, slidability of pen-input can be held. Moreover, image smearing due to pen-input can be reduced. Moreover, a good feeling of writing can be provided. A good result can be obtained in terms of reduction in weight, size and thickness, prevention of double reflection of external light, prevention of image blurring, and preventing of the crack of the liquid crystal panel due to impact.

As described above, one layer or two or more layers selected from various kinds of components such as a diffusing plate, an antiglare layer, an anti-reflection layer, a prism array, a lens array sheet, a light-scattering plate, a directional diffuser, a backlight unit, etc., which are known constituent members, can be disposed at option in suitable positions of the pen-input image display device.

### EXAMPLES

The invention will be described below more specifically in conjunction with Examples thereof. Incidentally, the term “parts” used in the following description means “parts by weight”.

The dynamic (shear) storage modulus G′ in each of the transparent rigid layer and transparent relaxing layer constituting the transparent laminate was measured as follows. The dynamic storage modulus G′ at 20° C. was measured by a viscoelastic spectrometer (“ARES apparatus” manufactured by Rheometric Scientific Inc.) on the basis of temperature-dispersion measurement at a frequency of 1 Hz.

### Example 1

(1) Surface-Treated Film

A polyethylene terephthalate film (“NO5S” manufactured by Kimoto Ltd.) subjected to an antiglare hard coating treatment and having a thickness of 125 μm was used.

(2) Transparent Rigid Layer

100 parts of 3,4-epoxycyclohexylmethyl-3,4-epoxycyclohexane carboxylate, 120 parts of methyl tetrahydrophthalic anhydride as a curing agent and 2 parts of tetra-n-butylphosphoniumO,O-diethylphosphodithioate as a curing accelerator were mixed while stirred. An epoxy resin film 600 μm thick was thermally cured at 180° C. for 30 minutes by a flow casting method. Thus, a transparent rigid layer was prepared. The dynamic storage modulus G′ of the transparent rigid layer at 20° C. was as shown in Table 1.

(3) Transparent Relaxing Layer

In a reactor having a cooling pipe, a nitrogen-import pipe, a thermometer, an ultraviolet irradiator and a stirrer, 100 parts of 2-ethylhexyl acrylate and 0.1 parts of 2,2-dimethoxy-2-phenylacetophenone (photopolymerization initiator) were put and polymerized by ultraviolet irradiation to prepare a polymer-monomer mixture solution at a rate of polymerization of 8% by weight.

In 100 parts of the mixture solution, 0.3 parts of trimethylolpropane triacrylate (crosslinking agent), 0.2 parts of 1-hydroxy-cyclohexyl-phenylketone (photopolymerization initiator) and 1 part of an anti-oxidant (“IRGANOX 1010” manufactured by Ciba Specialty Chemicals Inc.) were mixed to prepare a composition. This composition was applied on a 100 μm-thick polyester separator (“PET separator MRF” manufactured by Mitsubishi Polyester Film, LLC). The composition was covered with a 75 μm-thick polyester separator (“PET separator MRN” manufactured by Mitsubishi Polyester Film, LLC) which was a cover separator lower in peeling force than the former separator. While cooled to −15° C., the composition was irradiated with ultraviolet rays of 4,000 mJ/cm² by an ultraviolet lamp so as to be photopolymerized. Thus, a transparent relaxing layer (transparent relaxing adhesive layer) having a thickness of 1 mm was prepared. The dynamic storage modulus G′ of the transparent relaxing layer at 20° C. was as shown in Table 1.

(4) Transparent Adhesive Solution

While 96 parts of butyl acrylate, 3.9 parts of acrylic acid, 0.1 parts of 2-hydroxyethyl acrylate, 0.3 parts of azobisisobutylonitrile and 250 parts of ethyl acetate were stirred and mixed, a reaction was made at about 60° C. for 6 hours to prepare an acrylic polymer solution having a weight-average molecular weight of 1,630,000.

Into this acrylic polymer solution, 0.5 parts of an isocyanate polyfunctional compound (“CORONATE L” manufatcured by Nippon Polyurethane Industry Co., Ltd.) were added per 100 parts of the polymer solid content of the acrylic polymer solution to prepare a transparent adhesive solution.

(5) Transparent Laminate

The surface-treated film was laminated onto the transparent rigid layer by the transparent adhesive solution (the transparent adhesive layer was 25 μm thick). The transparent relaxing layer (transparent relaxing adhesive layer) was laminated onto the rear surface side of the transparent rigid layer. Thus, a transparent laminate was prepared.

(6) Optical Film

An 80 μm-thick polyvinyl alcohol film was stretched to five times in an aqueous solution of iodine and then dried. Triacetyl cellulose films as transparent protective films were bonded to both sides of the polyvinyl alcohol film by an adhesive to prepare a polarizing film.

Then, a 50 μm-thick polycarbonate film (manufactured by Kaneka Corp.) as a retardation plate was laminated onto an LCD panel side of the polarizing film by the transparent adhesive solution (the transparent adhesive layer was 25 μm thick) to prepare an optical film.

(7) Pen-Input Liquid Crystal Display Device

The transparent laminate was laminated onto the polarizing plate side of the optical film through the transparent relaxing layer. The retardation plate side of the optical film was laminated onto an LCD panel by the transparent adhesive solution (the transparent adhesive layer was 25 μm thick).

Then, the retardation plate side of the other optical film was laminated onto the rear surface side of the LCD panel by the transparent adhesive solution (the transparent adhesive layer was 25 μm thick) to produce an electromagnetic induction type pen-input liquid crystal display device.

### Example 2

A transparent laminate was prepared in the same manner as in Example 1 except that the thickness of the transparent relaxing layer was changed to 500 μm. The transparent laminate was used for producing an electromagnetic induction type pen-input liquid crystal display device in the same manner as in Example 1.

### Example 3

A transparent relaxing layer was prepared in the same manner as in Example 1 except that 100 parts of 2-ethylhexyl acrylate used for formation of the transparent relaxing layer were replaced by the same amount of butyl acrylate. The transparent relaxing layer was used for preparing a transparent laminate in the same manner as in Example 1. The transparent laminate was used for producing an electromagnetic induction type pen-input liquid crystal display device in the same manner as in Example 1.

### Example 4

A transparent relaxing layer was prepared in the same manner as in Example 1 except that 100 parts of 2-ethylhexyl acrylate used for formation of the transparent relaxing layer were replaced by 98 parts of isooctyl acrylate and 2 parts of acrylic acid. The transparent relaxing layer was used for preparing a transparent laminate in the same manner as in Example 1. The transparent laminate was used for producing an electromagnetic induction type pen-input liquid crystal display device in the same manner as in Example 1.

### Example 5

A transparent laminate was prepared in the same manner as in Example 1 except that the thickness of the transparent rigid layer was changed to 300 μm. The transparent laminate was used for producing an electromagnetic induction type pen-input liquid crystal display device in the same manner as in Example 1.

### Comparative Example 1

A transparent laminate was prepared in the same manner as in Example 1 except that the thickness of the transparent relaxing layer was changed to 25 μm. The transparent laminate was used for producing an electromagnetic induction type pen-input liquid crystal display device in the same manner as in Example 1.

### Comparative Example 2

A transparent laminate was prepared in the same manner as in Example 1 except that use of the transparent rigid layer was omitted. The transparent laminate was used for producing an electromagnetic induction type pen-input liquid crystal display device in the same manner as in Example 1.

The dynamic storage modulus at 20° C. and the thicknesses of the transparent rigid layer and transparent relaxing layer constituting the transparent laminate used in each of the electromagnetic induction type pen-input liquid crystal display devices according to Examples 1 to 5 and Comparative Examples 1 and 2 were gathered in Table 1.

TABLE 1

| | |
|---|---|
| Transparent | Transparent |
| Rigid Layer | Relaxing Layer |

| | G′ | Thickness | G′ | Thickness |
|---|---|---|---|---|
| | (Pa) | (μm) | (Pa) | (μm) |
| Example 1 | 2 × 10⁹ | 600 | 3 × 10⁴ | 1,000 |
| Example 2 | 2 × 10⁹ | 600 | 3 × 10⁴ | 500 |
| Example 3 | 2 × 10⁹ | 600 | 7 × 10⁴ | 1,000 |
| Example 4 | 2 × 10⁹ | 600 | 5 × 10⁴ | 1,000 |
| Example 5 | 2 × 10⁹ | 300 | 3 × 10⁴ | 1,000 |
| Comparative | 2 × 10⁹ | 600 | 3 × 10⁴ | 25 |
| Example 1 | | | | |
| Comparative | — | — | 3 × 10⁴ | 1,000 |
| Example 2 | | | | |

Then, performance of each of the electromagnetic induction type pen-input liquid crystal display devices according to Examples 1 to 5 and Comparative Examples 1 and 2 was evaluated by the following method. Results thereof were as shown in Table 2.

### Evaluation of Image Smearing

An input pen having a shape with a radius of about 0.8 mm and made of a polyacetal resin as a main material was used. The spread of liquid crystal was measured when the input pen touched the outermost surface of the liquid crystal display device in a pen-input evaluation condition that the load on the pen was 300 g constant. A tablet PC (“DynaBook SS3500” manufactured by Toshiba Corp.) was used as the liquid crystal panel.

◯: Good without image smearing (the spread of liquid crystal was smaller than 10 mm diameter)

x : Bad with image smearing (the spread of liquid crystal was not smaller than 10 mm diameter)

### Evaluation of Scratch Resistance

An input pen for evaluation of image smearing was used. A linear distance of 100 mm was overwritten 10,000 times at a speed of 5 m/min under a pen load of 500 g. The portion where the linear distance had been overwritten was observed by eye and evaluated as follows.

◯: Little scratch mark

Δ: Inconspicuous but a little scratch mark

x : Conspicuous peeling and scratch mark of the hard coated layer

### Evaluation of Crack Preventing Characteristic

A steel ball having a diameter of 50 mm and a weight of 510 g was dropped down from a height of 10 cm in a pendulum manner or the same impact as this was given by a spring impact hummer. A judgment was made by eye observation as to whether glass cracks occurred in the liquid crystal panel or not.

Incidentally, the impact energy generated when the steel ball was dropped down like a pendulum was calculated as ball weight (kgf)×height (m)×gravitational acceleration (m/s²)=0.51×0.1×9.81. That is, the impact energy was about 0.5 J. The crack preventing characteristic of the LCD panel has not been particularly standardized but, when the impact energy is not lower than 0.5 J, a decision that the LCD panel passed this test can be made from the actual situation.

◯: Little crack and break observed.

x : Crack and break observed clearly (with image smearing)

### Evaluation of Sinking Depth and Elastic Deformation

The input pen for evaluation of image smearing was used. The depth by which the input pen sunk when the input pen touched the surface of the panel plate under a load of 300 g with interposition of a glass plate having a predetermined thickness and the depth by which the input pen sunk when the input pen touched the surface of the panel plate under a load of 300 g without interposition of the glass plate were read from a dial gauge connected to an upper portion of the pen. The sinking depth Y was calculated as Y=(X₂−X₁−glass thickness) in which X₁ was a value read when the glass plate was interposed between the pen and the panel, and X₂ was a value read when there was no glass plate interposed between the pen and the panel.

Whether the contact portion was restored to its original state within two seconds when the load was removed was observed. The case where the contact portion was restored to its original state was evaluated as “good recovery”. The case where the contact portion was not restored to its original state was evaluated as “bad recovery”. As a result, in each of Examples 1 to 5 and Comparative Examples 1 and 2, the recovery was good.

### Evaluation of Dynamic Friction Coefficient

Juracon (material: polyacetal resin, pen point: 0.8 mm radius) manufactured by Nihon Polyplastic Co., Ltd. was used as an input pen. The dynamic friction coefficient was measured by a Heidon surface measuring apparatus (Type: HEIDON-14D) manufactured by Shinto Scientific Co., Ltd. in the condition that the moving speed of the input pen relative to the surface of the panel plate was 1,000 mm/min and the pen load was 500 g.

TABLE 2

| | | | Crack | | |
|---|---|---|---|---|---|
| | | | Preventing | Sinking | Dynamic |
| | Image | Scratch | Char- | Depth | Friction |
| | Smearing | Resistance | acteristic | (μm) | Coefficient |
| Example 1 | ◯ | ◯ | ◯ | 25 | 0.25 |
| Example 2 | ◯ | ◯ | ◯ | 22 | 0.25 |
| Example 3 | ◯ | ◯ | ◯ | 22 | 0.25 |
| Example 4 | ◯ | ◯ | ◯ | 25 | 0.25 |
| Example 5 | ◯ | ◯ | ◯ | 48 | 0.25 |
| Comparative | X | ◯ | X | 10 | 0.40 |
| Example 1 | | | | | |
| Comparative | X | ◯ | ◯ | 130 | 0.25 |
| Example 2 | | | | | |

### Example 6

(1) Surface-Treated Film

A 125 μm-thick polyethylene terephthalate film (“G01S” manufactured by Kimoto Ltd.) subjected to a hard coating treatment was used.

(2) Touch Panel

A non-hard-coat-treated surface of the surface-treated film was subjected to a plasma treatment under an argon atmosphere. An ITO thin layer was formed on the plasma-treated surface of the surface-treated film by sputtering. Then, a silver electrode was printed on the ITO surface. Thus, a transparent electrically conductive film was produced. A pair of transparent electrically conductive films produced in this manner were laminated to each other through a spacer so that the silver electrode sides of the transparent electrically conductive films faced each other. Thus, a touch panel was produced.

(3) Transparent Rigid Layer

A 600 μm-thick transparent rigid layer was prepared in the same manner as in Example 1.

(4) Transparent Relaxing Layer

A 1 mm-thick transparent relaxing layer (transparent relaxing adhesive layer) was prepared in the same manner as in Example 1.

(5) Transparent Adhesive Solution

A transparent adhesive solution was prepared in the same manner as in Example 1.

(6) Transparent Laminate

The touch panel was laminated onto the transparent rigid layer by the transparent adhesive solution (the transparent adhesive layer was 25 μm thick). The transparent relaxing layer (transparent relaxing adhesive layer) was laminated onto the rear surface side of the transparent rigid layer. Thus, a transparent laminate was produced.

(7) Optical Film

An optical film was prepared in the same manner as in Example 1.

(8) Pen-Input Liquid Crystal Display Device

The transparent laminate was laminated onto the polarizing plate side of the optical film through the transparent relaxing layer. The retardation plate side of the optical film was laminated to the LCD panel by the transparent adhesive solution (the transparent adhesive layer was 25 μm thick). Then, the retardation plate side of the other optical film was laminated onto the rear surface side of the LCD panel by the transparent adhesive solution (the transparent adhesive layer was 25 μm thick). Thus, a resistive film type pen-input liquid crystal display device was produced.

### Example 7

A transparent laminate was prepared in the same manner as in Example 6 except that the thickness of the transparent relaxing layer was changed to 500 μm. The transparent laminate was used for producing a resistive film type pen-input liquid crystal display device in the same manner as in Example 6.

### Example 8

A transparent relaxing layer was prepared in the same manner as in Example 6 except that 100 parts of 2-ethylhexyl acrylate used for formation of the transparent relaxing layer were replaced by the same amount of butyl acrylate. The transparent relaxing layer was used for preparing a transparent laminate in the same manner as in Example 6. The transparent laminate was used for producing a resistive film type pen-input liquid crystal display device in the same manner as in Example 6.

### Example 9

A transparent relaxing layer was prepared in the same manner as in Example 6 except that 100 parts of 2-ethylhexyl acrylate used for formation of the transparent relaxing layer were replaced by 98 parts of isooctyl acrylate and 2 parts of acrylic acid. The transparent relaxing layer was used for preparing a transparent laminate in the same manner as in Example 6. The transparent laminate was used for producing a resistive film type pen-input liquid crystal display device in the same manner as in Example 6.

### Example 10

A transparent laminate was prepared in the same manner as in Example 6 except that the thickness of the transparent rigid layer was changed to 300 μm. The transparent laminate was used for producing a resistive film type pen-input liquid crystal display device in the same manner as in Example 6.

### Comparative Example 3

A transparent laminate was prepared in the same manner as in Example 6 except that the thickness of the transparent relaxing layer was changed to 25 μm. The transparent laminate was used for producing a resistive film type pen-input liquid crystal display device in the same manner as in Example 6.

### Comparative Example 4

A transparent laminate was prepared in the same manner as in Example 6 except that use of the transparent rigid layer was omitted. The transparent laminate was used for producing a resistive film type pen-input liquid crystal display device in the same manner as in Example 6.

The dynamic storage modulus at 20° C. and the thicknesses of the transparent rigid layer and transparent relaxing layer constituting the transparent laminate used in each of the resistive film type pen-input liquid crystal display devices according to Examples 6 to 10 and Comparative Examples 3 and 4 were gathered in Table 3.

TABLE 3

| | |
|---|---|
| Transparent | Transparent |
| Rigid Layer | Relaxing Layer |

| | G′ | Thickness | G′ | Thickness |
|---|---|---|---|---|
| | (Pa) | (μm) | (Pa) | (μm) |
| Example 6 | 2 × 10⁹ | 600 | 3 × 10⁴ | 1,000 |
| Example 7 | 2 × 10⁹ | 600 | 3 × 10⁴ | 500 |
| Example 8 | 2 × 10⁹ | 600 | 7 × 10⁴ | 1,000 |
| Example 9 | 2 × 10⁹ | 600 | 5 × 10⁴ | 1,000 |
| Example 10 | 2 × 10⁹ | 300 | 3 × 10⁴ | 1,000 |
| Comparative | 2 × 10⁹ | 600 | 3 × 10⁴ | 25 |
| Example 3 | | | | |
| Comparative | — | — | 3 × 10⁴ | 1,000 |
| Example 4 | | | | |

Then, performance of each of the resistive film type pen-input liquid crystal display devices according to Examples 6 to 10 and Comparative Examples 3 and 4 was evaluated by the same method as described above. Results thereof were as shown in Table 4. Incidentally, the “sinking depth” was measured as follows. The load was increased by the aforementioned method. After the gap between the ITO thin layers was eliminated, a load of 300 g was further applied. The depth by which the pen sunk in accordance with the applied load was measured as the “sinking depth”.

TABLE 4

| | | | Crack | | |
|---|---|---|---|---|---|
| | Image | | Preventting | Sinking | Dynamic |
| | Smear- | Scratch | Char- | Depth | Friction |
| | ing | Resistance | acteristic | (μm) | Coefficient |
| Example 6 | ◯ | ◯ | ◯ | 25 | 0.25 |
| Example 7 | ◯ | ◯ | ◯ | 22 | 0.25 |
| Example 8 | ◯ | ◯ | ◯ | 22 | 0.25 |
| Example 9 | ◯ | ◯ | ◯ | 25 | 0.25 |
| Example 10 | ◯ | ◯ | ◯ | 48 | 0.25 |
| Comparative | X | ◯ | X | 10 | 0.40 |
| Example 3 | | | | | |
| Comparative | X | ◯ | ◯ | 130 | 0.25 |
| Example 4 | | | | | |

It is apparent from the results shown in Tables 1 to 4 that each of the pen-input liquid crystal display devices according to Examples 1 to 10 based on the configuration of the invention exhibits no image smearing to pen-input and excellent in scratch resistance and excellent in crack preventing characteristic of the liquid crystal panel. On the contrary, the pen-input liquid crystal display devices according to Comparative Examples 1 and 3 each using the transparent laminate having the excessively thin transparent relaxing layer and the pen-input liquid crystal display devices according to Comparative Examples 2 and 4 each using the transparent laminate having no transparent rigid layer exhibit image smearing and inferior in crack preventing characteristic.

The present application is based on Japanese Patent Application No. 2003-028299 and 2003-431998 filed on Feb. 5, 2003 and Dec. 26, 2003, respectively, and the contents thereof are incorporated herein by reference.

1. A transparent laminate for pen-input image display device, having, laminated in the following order,
a surface-treated layer;
a transparent rigid layer; and
a transparent relaxing layer having a thickness of from 0.2 to 2 mm.

2. The transparent laminate according to claim 1,
wherein the transparent relaxing layer is an adhesive.

3. The transparent laminate according to claim 1,
wherein the transparent relaxing layer has a thickness of from 0.2 to 1.5 mm.

4. The transparent laminate according to claim 1,
wherein the dynamic storage modulus G′ of the transparent rigid layer at 20° C. is not lower than 2×10⁸ Pa.

5. The transparent laminate according to claim 4,
wherein the dynamic storage modulus G′ of the transparent rigid layer at 20° C. is not lower than 5×10⁸ Pa.

6. The transparent laminate according to claim 1,
wherein the dynamic storage modulus G′ of the transparent relaxing layer at 20° C. is not higher than 1×10⁷ Pa.

7. The transparent laminate according to claim 6,
wherein the dynamic storage modulus G′ of the transparent relaxing layer at 20° C. is from 1×10³ to 7×10⁶ Pa.

8. The transparent laminate according to claim 1,
wherein the transparent rigid layer has a thickness of from 0.15 to 2 mm.

9. The transparent laminate according to claim 8,
wherein the transparent rigid layer has a thickness of from 0.2 to 1 mm.

10. The transparent laminate according to claim 1,
wherein the surface-treated layer comprises at least one selected from the group consisting of an anti-reflection layer, an anti-mirroring layer and a hard coated layer.

11. The transparent laminate according to claim 1,
wherein the transparent relaxing layer is formed from a polymer composite material including organic lamellar clay minerals,
wherein the transparent relaxing layer has a dynamic storage modulus at 20° C. of not higher than 6×10⁶ Pa.

12. The transparent laminate according to claim 11,
wherein the polymer composite material has a dynamic storage modulus at 20° C. of from 1×10³ to 1×10⁵ Pa.

13. The transparent laminate according to claim 1,
further comprising a pair of transparent electrically conductive layers,
wherein the transparent electrically conductive layers are provided between the surface-treated layer and the transparent rigid layer or between the transparent rigid layer and the transparent relaxing layer so as to face each other with separation of a predetermined distance.

14. A pen-input image display device comprising:
an image display panel; and
a transparent laminate having, laminated in the following order,
a surface-treated layer;
a transparent rigid layer; and
a transparent relaxing layer having a thickness of from 0.2 to 2 mm,
wherein the transparent laminate is directly laminated onto a visual surface side of the image display panel, so that the transparent relaxing layer is placed inward.

15. The pen-input image display device according to claim 14,
which has such elastic deformability when an input pen touches a surface of the display device under a load of 300 g that a contact portion of the display device sinks inward to a depth of from 20 to 100 μm, but the contact portion of the display device is restored to its original state when the load is removed.

16. (canceled)

17. (canceled)
